(19) United States
(12) Patent Application Publication
(10) Pub. No.: US 2017/0234003 A1
(43) Pub. Date: Aug. 17, 2017

(54) Integral temperature responsive fire suppressant modular interior system

(71) Applicant: Ian Gill Bemis, Bowie, MD (US)

(72) Inventor: Ian Gill Bemis, Bowie, MD (US)

(21) Appl. No.: 14/998,787

(22) Filed: Feb. 17, 2016

(51) Int. Cl. E04B 1/94; E04C 2/52; E04B 9/04; A62C 3/00; A62C 35/10

(52) U.S. Cl. CPC E04B 1/942; A62C 3/00; A62C 35/10; E04B 9/0457; E04C 2/526; E04B 2001/949

(57) ABSTRACT

A construction material consisting of a deployment system for a tire retardant substance, suitable for use in a wide variety of applications. This invention is designed to deploy a fire retardant substance in in response to the detection of an uncontrolled fire, thus minimizing or reducing risk of death, serious injury or property damage associated with uncontrolled fires when present in a habitable structure. The invention consists of a construction material which incorporates hinged or folding door(s) or flap(s) which contain a fire retardant substance within the construction material. When an uncontrolled fire is detected, the door(s) or flap(s) open and thus deploy the fire retardant substance onto the area affected by the uncontrolled fire.

### INVENTION BACKGROUND

1. Field of Invention

The invention to be described, specified, depicted and documented in this United States Non-Provisional Utility Patent Application, is a new and useful structural implement presently envisioned as an integral fire suppressant when affixed or otherwise placed in a stationary position on or integral to the interior of a structure. A currently envisioned means of utilizing this technology may consist of a ceiling tile (which may be compatible with the current art concerning the use and proliferation of Suspended Ceilings) or other board materials intended for use in a man-made structure. This invention may take the form of a construction material consisting of a fire retardant substance which is encased in a material that has an opening on one surface (which may be facing downward if this material is utilized in the construction of a ceiling) that is enclosed by a hinged door or flap. The door or flap opens in response to heat (such as would be encountered under conditions of an uncontrolled fire) in a manner to be described within this specification, thus dispensing the fire retardant contents of the casing into the area below the placement of this invention, and thus extinguishing any uncontrolled fire in that location. By means of dispensing a fire retardant compound or particulates into an engulfed or heated area (which may be the interior of a structure) this invention is intended to extinguish the fire, slow combustion, prevent or control the spread of a maverick inferno, work in concert with other fire prevention, control or safety apparatus or lower the ambient temperature to reduce the likelihood of dangerous phenomenon such as backdraft or flashover.

2. Invention Background and Description of Prior Art

This Patent Application improves upon the invention detailed U.S. patent application Ser. No. 14/998,787 invented by Ian Bemis, titled Integral Temperature Responsive Fire Suppressant Modular Interior System. The invention described in U.S. patent application Ser. No. 14/998,787 consists of a building material comprised of a powder or foam which is encased in an outer shell of polymer which will melt, disintegrate, or otherwise deform under conditions of high heat (such as an uncontrolled fire). Such conditions will expose the powdered foam core (which may consist of high expansion firefighting foam powder in one embodiment of this invention) which, if the product of this invention is placed over an area affected by an uncontrolled inferno, the powdered foam will fall and disperse onto the area effected by the fire, separating the fuel source of the fire from supply of oxygen, and thus extinguish the fire. This invention improves upon the invention described in U.S. patent application Ser. No. 14/998,787 in a manner which is to be described within this document.

The current art regarding fire prevention, and engineered structural resilience in the event of an uncontrolled fire within a structure is the result of over a century of technical innovation and subsequent government codification of standards with regards to the inherent safety of habitable structures in the event of a fire. While the pedigree of practical invention relating to the applied science of active mechanical fire prevention and Active Fire Protection (AFP) may date to a primitive sprinkler system designed or constructed to the specifications of the great Leonardo da Vinci of Florence, the first United States Patent relating to the invention of an automated sprinkler system was U.S. Pat. No. 131,370, published Sep. 17, 1872, titled Improvement in Fire-Extinguishers, invented by Philip W. Pratt. While the invention that is the subject of this patent application seeks to achieve a similar ends of fire prevention and control, the present invention embodies a sufficiently differentiated form as to negate any tangible purpose in further elaboration on the prior art as it relates to automatic hydraulic fire suppression/sprinkler systems in current or past use.

Suspended ceilings of various format and structural composition, although virtually ubiquitous by currents standards of art, have existed in their presently recognizable form for little over half a century. As the invention that is subject to this patent application may take form as a suspended ceiling tile (or other precursor component of a man-made structure), it benefits the interest of the party viewing this document to better understand the prior art of construction materials composition (one such composition to be briefly described will be the current state of the art ceiling tile composition), as well as a brief description of the methods of implementing such materials to form certain structural components. Current commonly utilized methods of constructing interior surfaces of a structure, which include but are not limited to the ceilings, include drywall, sheet-rock, gypsum board, plaster, various polymers, fiber board, artificial and natural rubber, latex, pulp board, paper board, particle board, as well as a myriad of additional materials and compositions of such materials of various forms. The form and composition of such a building material is tailored to a specific or general application in order to best suit the role in which such a construction product is utilized. With the exception of U.S. patent application Ser. No. 14/998,787, no form of interior construction material has been designed or proliferated as an active fire suppressant system.

### BRIEF DESCRIPTION OF THE INVENTION

The invention described, illustrated, and documented herein is a new and innovative improvement to fire safety, control and prevention for use in habitable structures. The aforementioned invention consists of a building material comprised of a fire retardant substance (which may consist of powder or foam) which is encased in an outer shell that incorporates (one or more) hinged or folded door(s) or flap(s) on one side of the casing (which may be the downward facing side). The door or flap is held in the closed position until a fire is detected, in which case the flap is released, thus deploying the fire retardant materials onto the surrounding area that is subject to conditions of high heat (such as would be encountered during an uncontrolled fire).

In one or more embodiments of this invention, the door or flap is held in the stationary closed position by means of a meltable adhesive that will soften, deform or melt at elevated temperatures, such as would be encountered during an uncontrolled fire. The melting of the adhesive (in the forms of this invention that utilize the adhesive, will allow the door or flap to respond to gravitational forces and fall into an open position, and thus releasing the fire retardant contents encased. Gravity will then act upon the fire retardant materials, which will then disperse into the area below the location of this invention, and work to suppress any uncontrolled fire in that location. Various embodiments of this invention may incorporate weighted doors or flaps in order to overcome resistance to the opening of the doors or flaps. One embodiment of this invention may consist of a construction material for use in ceilings of habitable structures, in order to best utilize the natural forces of heat convection and gravity, as an area that is affected by an uncontrolled fire will cause a large amount of heat energy to escape into the air, and rise to the ceiling, thus releasing the door or flaps, and allowing the inner foam powder core to fall and blanket the area affected by the fire and extinguish the blaze. Certain embodiment(s) of this invention may take the form of a tile for use in a suspended ceiling. If this invention is put into such a construction application where a sprinkler system is present, this invention will work in conjunction with the sprinkler system, provided that (as in one embodiment of this invention) the powder core is comprised of expanding firefighting foam.

### DETAILED DESCRIPTION OF THE INVENTION

In accordance with 35 U.S.C. §112(a) a detailed description of the invention that is the subject of this application is included below. Nothing described or depicted herein should be construed as to limit the useful scope of the invention or diminish the utility of the invention with regards to an application or configuration other than the possible configuration(s) specified below.

For the purposes of this description and any resultant claims, the term “habitable structure” or shall include, but is not limited to any ship, boat, barge, or seagoing vessel, or offshore platform as well as any conventional terrestrial and subterranean habitable structures, or any other man made structure, including vehicles, that may accommodate or house humans, animals, plants, other organisms, or property.

The invention consists of a construction material, intended for use on or within a habitable structure, consisting of a powder core (that may consist of firefighting foam) which is encased within an external shell. The outer shell has an opening on one side (which may face downward, depending upon the configuration and desired application of this invention) which, under normal circumstances is enclosed by (one or more) door(s) or flap(s). The door or flap opens in the event of a fire, releasing the fire retardant materials that are encased within the product of this invention. Various embodiments of this invention may implement differentiated methods and designs of the door(s) or flap(s) including but not limited to, varying numbers of the doors(s) or flap(s), that are a component of this invention. Likewise, various methods of opening these door(s) or flap(s) in response Ir, fire may be implemented in various embodiments of this invention. Nothing within this document should be construed to prescribe any particular form(s) of this invention as the sole intended form(s) of this invention.

In one embodiment of this invention, the release of the door(s) or flap(s) is triggered in response to heat. For the purposes of this description we shall assume that the invention is placed in a position above the location where a fire occurs. As heat convects upward towards the construction material that is the subject of this patent application, the door or flap opens in response to conditions of high heat, which are encountered during an uncontrolled fire. One form of a heat activated embodiment of this invention utilizes a meltable adhesive to secure the door(s) or flap(s) in the closed position under normal circumstances.

Any adhesive which is appropriate under general or specific design requirements may be utilized, as a vast array of adhesives may be implemented for use in this invention, with various different adhesives fulfilling particular requirements such as a specific melting (or deforming) temperature or certain adhesives possessing greater economic viability in the manufacture of this construction material. As many viable placements of the adhesive (in the forms of this invention that utilize an adhesive material to secure the door(s) or flap(s) in a closed position under normal circumstances) exist, manufacturers of this invention may differentiate the placement of the adhesive to suit various needs. Any described or depicted placement of the adhesive within this document shall not be construed to limit the scope of this invention to any particular placement of this adhesive.

Various embodiments of this invention that utilize a heat or temperature responsive adhesive (which may melt or otherwise deform in response to heat) to affix the aforementioned door(s) or flap(s) which enclose a fire retardant material within the body of the construction material that is the subject of this Utility Patent Application, may improve on prior art as outlined in U.S. patent application Ser. No. 14/998,787 invented by Ian Bemis, titled Integral Temperature Responsive Fire Suppressant Modular Interior System. The invention described in U.S. patent application Ser. No. 14/998,787 consists of a building material comprised of a powder or foam which is encased in an outer shell of polymer which will melt, disintegrate, or otherwise deform under conditions of high heat (such as an uncontrolled fire). The invention that is the subject of the present Application provides for an enhanced method of utilizing a partially meltable casing, where in one embodiment of this invention, the adhesive used to retain the door(s) or flap(s) of the construction material is an adhesive which will melt or deform in response to heat.

This invention may be especially useful in the event that a structure is affected by a fire fueled by lipids such as oil, grease, or petroleum products, or certain flammable hydrocarbon polymers, under which circumstances fire suppression by convention means (water) is ineffective, if not entirely inadvisable. As lipids such as these are lighter than water, and many hydrocarbon polymers may melt or decompose under high heat conditions into highly combustible lipids with similar properties, spraying water by means of convention fire suppression apparatus, may result in the water boiling under the burning lipid, and the resultant steam dispersing such burning lipids in a dangerous, explosion like event. As such conventional hydraulic sprinkler systems may be inappropriate, or even inherently hazardous in certain circumstances to which a powder, foam or particulate fire suppression system (such as may be implemented in certain embodiments of this invention) may be better suited for the numerous application where flammable lipids or polymers may be present. In addition, this invention may prevent loss of life or property under conditions where fire crews are only equipped with water as a fire suppressant, or under circumstances which would require additional, time consuming action by such fire crews to obtain a more suitable fire suppressant.

As stated previously within this specification, this Application for a United States Utility Patent claims the benefit of U.S. patent application Ser. No. 14/998,787 invented by Ian Bemis, titled Integral Temperature Responsive Fire Suppressant Modular Interior System. The invention that is the subject of this application improves upon the prior art outlined in application Ser. No. 14/998,787 by providing a new and improved deployment system for the fire retardant core that is the principal innovative component of the invention that is the subject of application Ser. No. 14/998,787. The powder core, as illustrated in application Ser. No. 14/998,787, may be compressed or tightly packed within a casing is intended to control, suppress, extinguish, or aid other fire control measures (such as a sprinkler system) to extinguish an uncontrolled fire within a habitable structure. While many suitable materials exist for the industry to utilize as this foam, in at least one embodiment of this invention the foam consists of a purpose designed composition of solid-state firefighting foam. The mixture and composition of such a foam for use in this invention will depend on the particular application in which the product is intended to be employed by the end user. As certain compositions of foams will perform more effectively in the circumstances for which they are designed to be best suited for the scope of this invention should not be limited to any particular type or composition of firefighting foam or other powder substance which may be used in this role.

Various embodiments of this invention may utilize weighted door(s) or flap(s) to provide a gravitational bias towards the open position of the doors(s) or flap(s), and ensure the rapid deployment of the fire retardant material in the event that stimulus indicating an uncontrolled fire is encountered. Materials of increased density and weight may be placed on or integral to the door(s) or flap(s), which retain the fire retardant material encased within the product of this invention under normal (where fire is not present) circumstances, to ensure that the doors or flaps to open with improved speed and reliability. These weight adding materials may be comprised of any substance appropriate to such an application.

Certain application(s) or embodiment(s) of this invention may consist of a tile intended for use in a suspended ceiling. In the event that this invention is embodied in the form of a tile, it may incorporate one or several characteristics previously described within this document. Suspended ceilings are commonly utilized in the construction of large structures of substantial monetary value that commonly serve a commercial purpose, or as public accommodation. For over a century these structures have been the target of substantial legislation, regulatory action, and litigation concerning safety in the event of a fire. Insurers of these properties may also instate additional standards with regards to fire safety of both commercial structures and public accommodations with regards to fire related loss and casualty. As this invention will be of its greatest practical use if utilized in the construction of large structural installations, including commercial or industrial propel lies or public accommodations which commonly employ the use of suspended ceilings in their construction, it is likely that the greatest benefit of this invention will embody the form(s) if this invention that may take the form of a tile for use in a suspended ceiling.

### DESCRIPTION OF INCLUDED DRAWINGS

The illustrations and diagrams of the invention in its intended application(s) provided within this document correspond to an enumerated description below, in order to aid the reader in ascertaining a clear and comprehensive understanding of the nature and function of the invention. Nothing described or depicted herein should be construed as to limit the useful scope of the invention or diminish the utility of the invention to an application or configuration other than as in the context as it is described below, as pertaining to certain applications illustrated within this document.

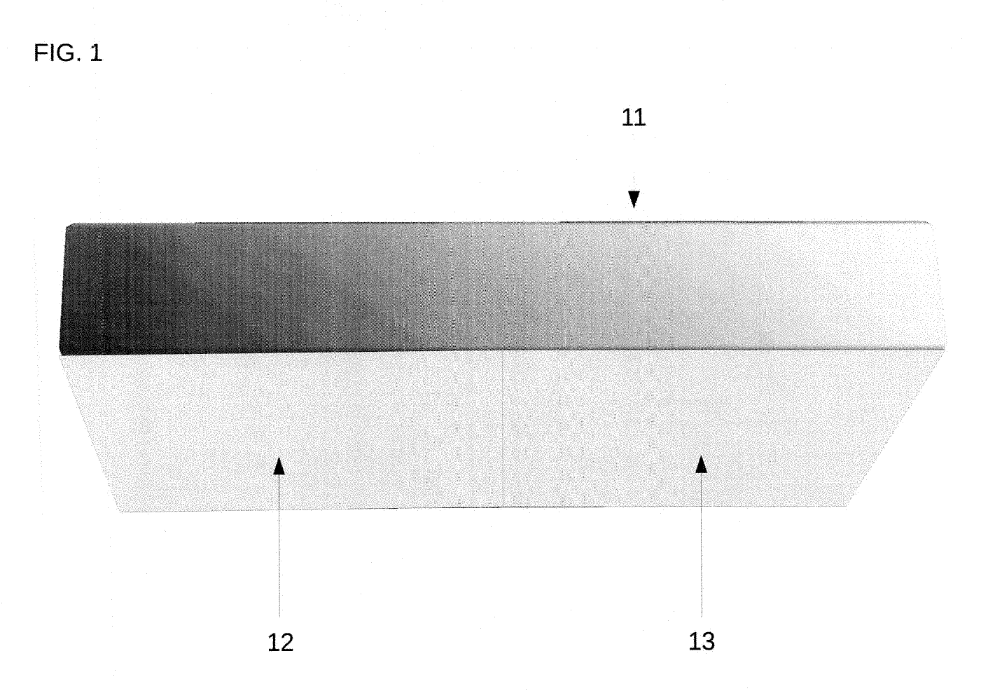

Figure (FIG. 1): A three-dimensional illustration of possible embodiment of this invention, in the form of a construction material consisting of at least one element of this invention. FIG. 1 depicts a construction material that prominently features door(s) or flap(s) which deploy a fire retardant material in a manner consistent with the descriptions of such within this specification.

### Reference Numerals with Respect to Figure (FIG.) 1:

11: Casing

12: Door or flap

13: Door or flap

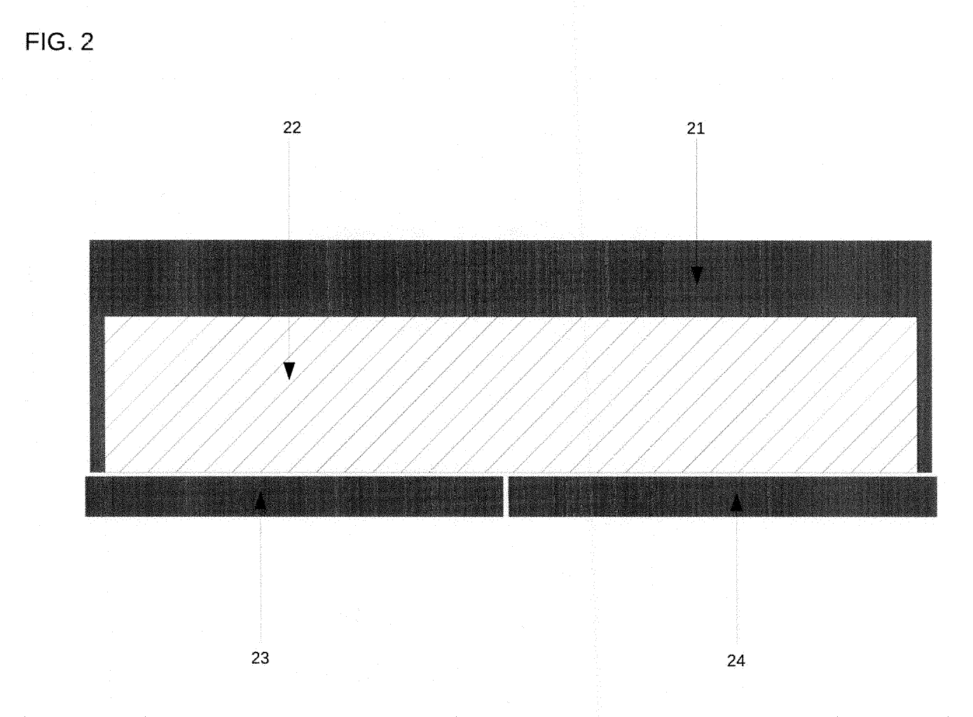

Figure (FIG.) 2: A two-dimensional (cutaway) illustration of a possible embodiment of this invention, in the form of a construction material consisting of at least one element of this invention. FIG. 2 depicts a construction material that prominently features doors(s) or flap(s) which deploy a fire retardant material in a manner consistent with the descriptions of such within this specification.

Reference numerals with respect to Figure (FIG.) 2:

21: Casing

22: Fire retardant material

23: Door or flap

24: Door or flap

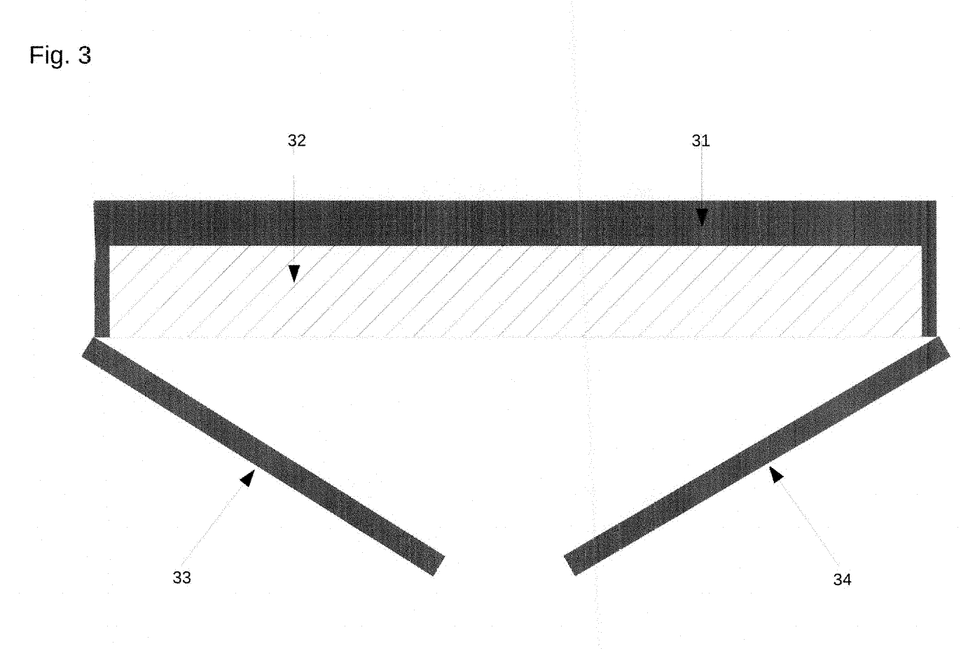

Figure (FIG.) 3: A two-dimensional (cutaway) illustration of a possible embodiment of this invention, in the form of a construction material consisting of at least one element of this invention. FIG. 3 depicts a construction material that prominently features doors(s) or flap(s) in a semi open position.

Reference numerals with respect to Figure (FIG.) 3:

31: Casing

32: Fire retardant material

33: Door or flap depicted in a semi open position

34: Door or flap depicted in a semi open position

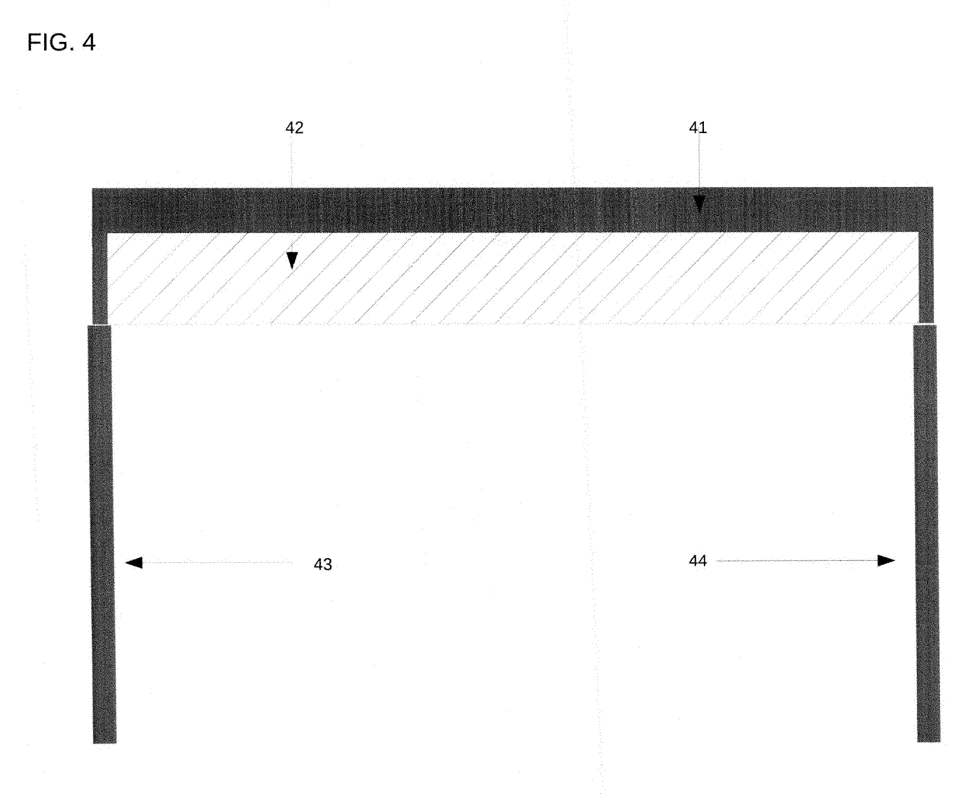

Figure (FIG.) 4: A two-dimensional (cutaway) illustration of a possible embodiment of this invention, in the form of a construction material consisting of at least one element of this invention. FIG. 4 depicts a construction material that prominently features doors(s) or flap(s) in an open position.

Reference numerals with respect to Figure (FIG.) 4:

41: Casing

42: Fire retardant material

43: Door or flap depicted in an open position

44: Door or flap depicted in an open position

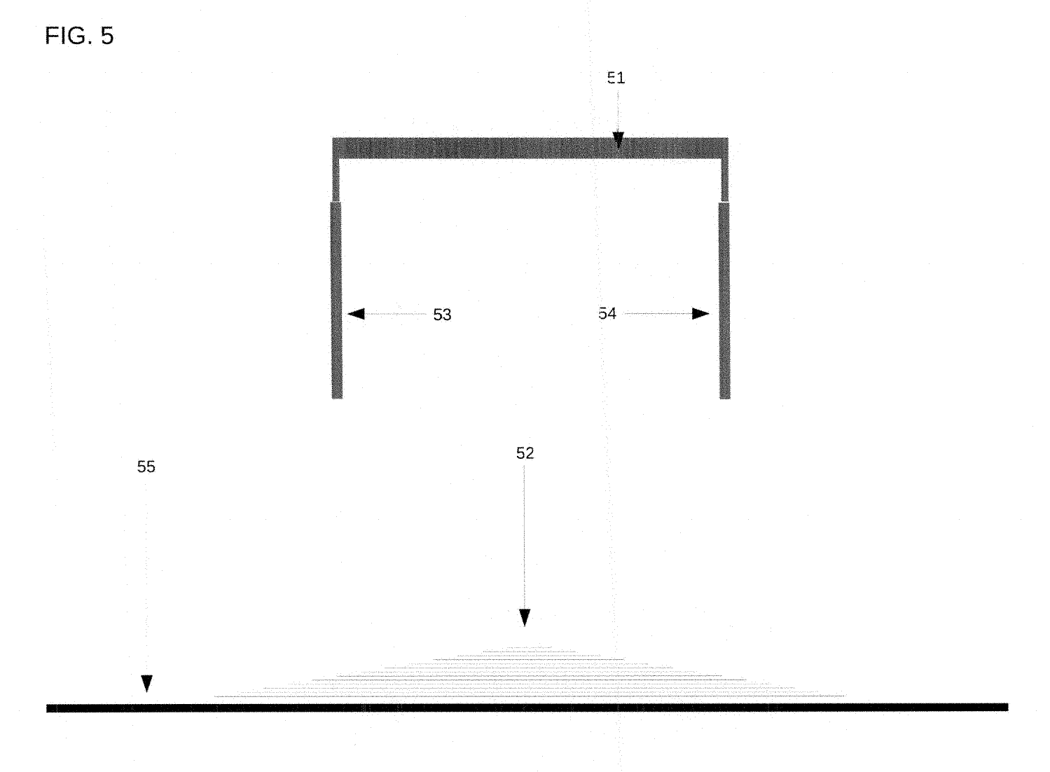

Figure (FIG. 5: A two-dimensional (cutaway) illustration of a possible embodiment of this invention, in the form of a construction material consisting of at least one element of this invention. FIG. 5 depicts the deployment of the fire retardant material to a surface located below the placement of a product of this invention, upon the opening of the door(s) or flap(s) which contain the fire retardant material under normal conditions.

Reference numerals with respect to Figure (FIG.) 5:

51: Casing

52: Fire retardant material, deployed to a surface below

53: Door or flap depicted in open position

54: Door or flap depicted in open position

55: A surface, onto which the fire retardant material has been deployed

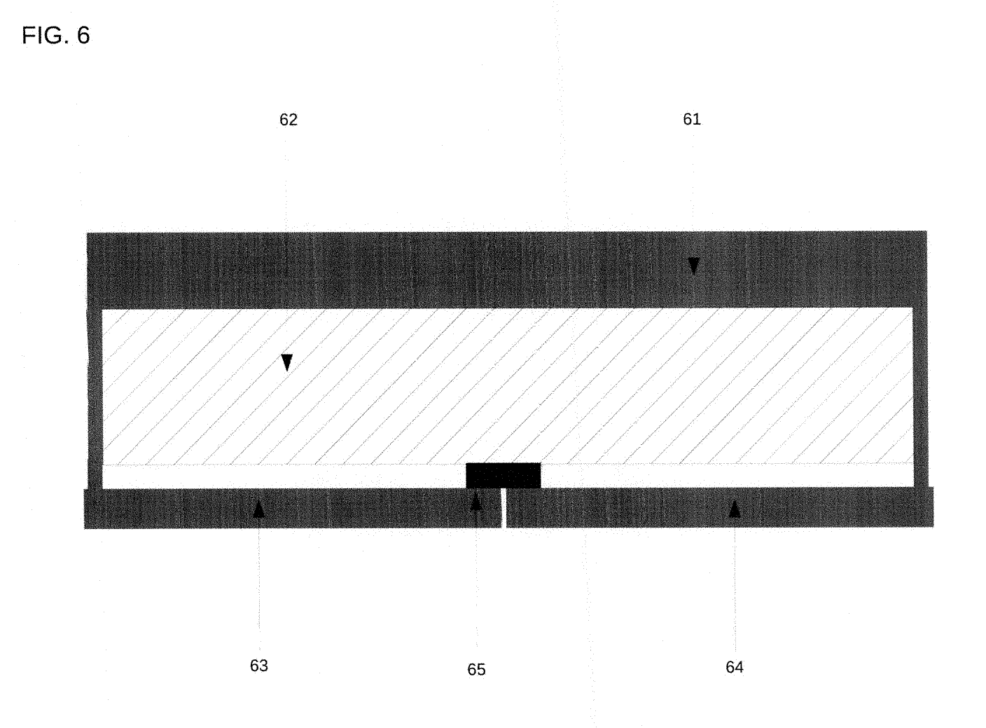

Figure (FIG.) 6: A two-dimensional (cutaway) illustration of a possible embodiment of this invention, in the form of a construction material consisting of at least two elements of this invention. FIG. 6 depicts a construction material that prominently features doors(s) or flap(s) which deploy a fire retardant material. The doors or flaps are retained in the closed position by a meltable adhesive substance that will melt or otherwise deform in response to heat stimulus, such as may be encountered in the event of an uncontrolled fire.

Reference numerals with respect to Figure (FIG.) 6:

61: Casing

62: Fire retardant material

63: Door or flap (retained in closed position)

64: Door or flap (retained in closed position)

65: Meltable adhesive which retains the door(s) or flap(s) in a closed position

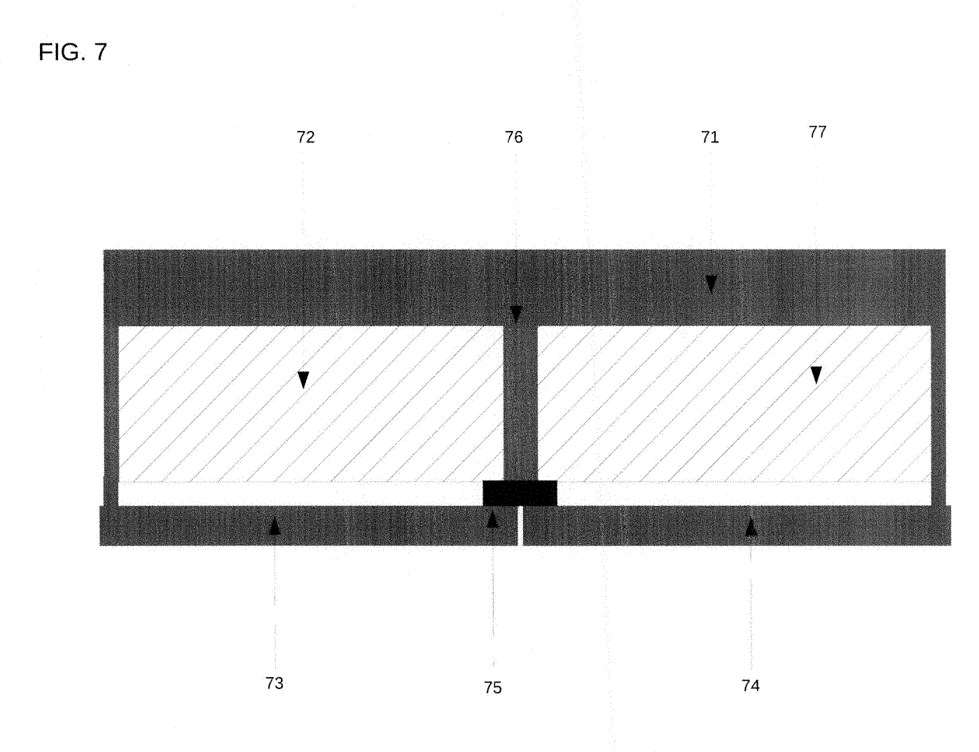

Figure (FIG.) 7: A two-dimensional (cutaway) illustration of a possible embodiment of this invention, in the form of a construction material consisting of at least two elements of this invention. FIG. 7 depicts a construction material consisting of a casing that encloses a fire retardant material, which may be deployed under circumstances of high heat (such as would be encountered in the event of an uncontrolled fire. The fire retardant material is enclosed by door(s) or flap(s), which under normal circumstances are affixed in a closed position by a meltable adhesive. The interior of the construction material containing the fire retardant substance is bifurcated into two chambers by an internal pillar or wall. Affixed to the outward facing end of the pillar or wall is the meltable adhesive which maintains the door(s) or flap(s) in the closed position

Reference numerals with respect to Figure (FIG.) 7:

11: Casing

72: Fire retardant material

73: Door or flap

74: Door or flap

75: Meltable adhesive which retains the door(s) or flap(s) in a closed position

76: Pillar or wall to which the adhesive is affixed

77: Fire retardant material

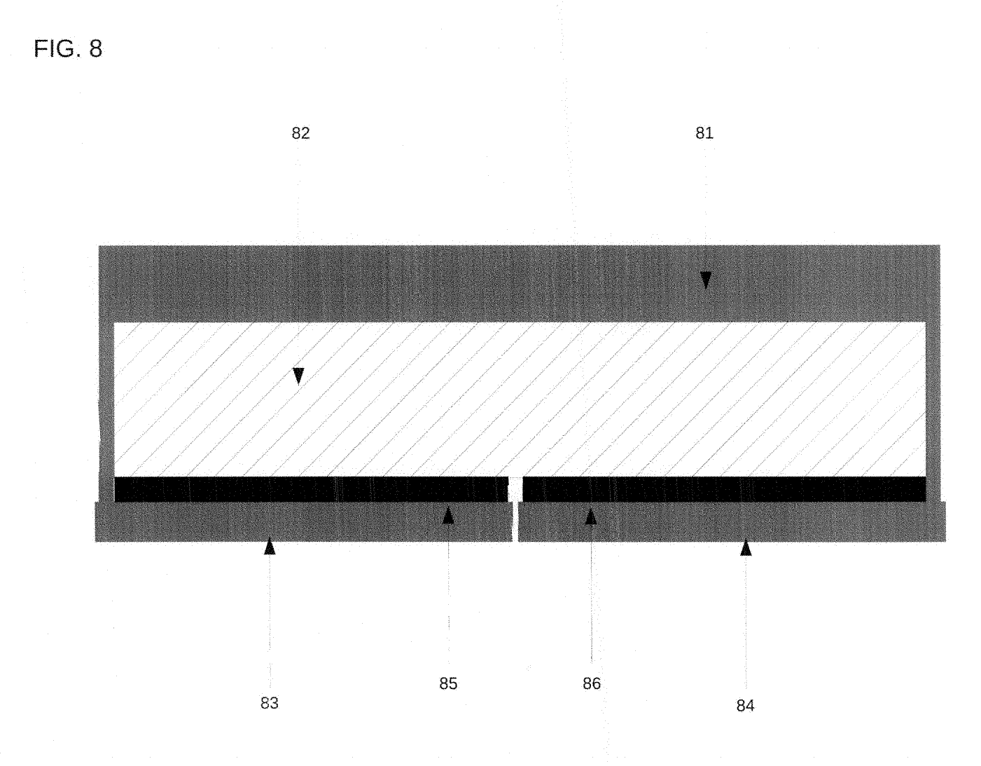

Figure (FIG.) 8: A two-dimensional (cutaway) illustration of a possible embodiment of this invention, in the form of a construction material consisting of at least two elements of this invention. FIG. 8 depicts a construction material that prominently features doors(s) or flap(s) which deploy a fire retardant material. The doors or flaps are retained in the closed position by at least two sections of a meltable adhesive substance that will melt or otherwise deform in response to heat stimulus, such as may be encountered in the event of an uncontrolled fire. In this depiction of a possible embodiment of the invention, the (meltable) adhesive layer spans the entire portion of the hinged door(s) or flap(s).

Reference numerals with respect to Figure (FIG.) 8:

81: Casing

82: Fire retardant material

83: Door or flap

84: Door or flap

85: Meltable adhesive

86: Meltable adhesive

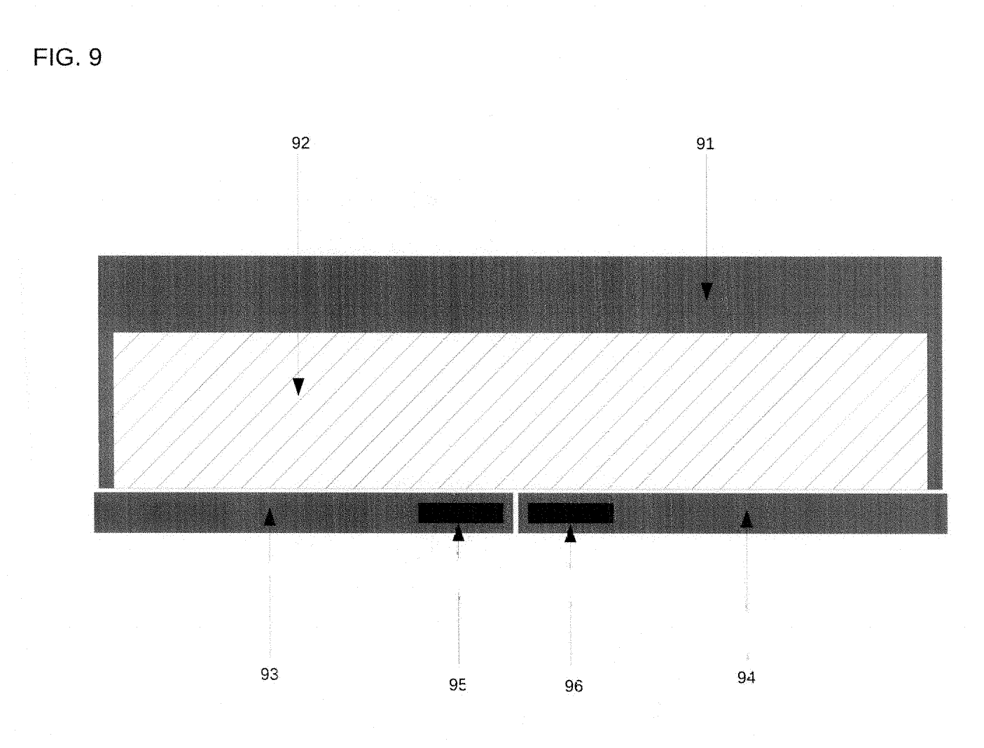

Figure (FIG.) 9: A two-dimensional (cutaway) illustration of a possible embodiment of this invention, in the form of a construction material consisting of at least two elements of this invention. FIG. 9 depicts a construction material that prominently features doors(s) or flap(s) which deploy a fire retardant material. The door(s) or flap(s) are weighted in a manner as to assist the opening of the door(s) or flap(s) by providing an increased gravitational bias towards the open position.

Reference numerals with respect to Figure (FIG.) 9:

91: Casing

92: Fire retardant material

93: Door or flap

94: Door or flap

95: Weighted portion of door or flap

96: Weighted portion of door or flap

I claim as my invention:

1) A Construction material, as described within this document, consisting of a fire retardant core (which may consist of powder, foam or any other suitable material) embedded within a meltable casing.

2) A fire retardant core suitable for use in such a construction material as described in claim 1, which is consistent with the descriptions of such within this document.

3) A meltable casing suitable for use in such a construction material as described in claim 1, which is consistent with the descriptions of such within this document.

4) The use of a fire retardant powder or foam as a component of a construction material in a manner consistent with the description included within this document.

5) The use of a fire retardant material as described in claim (4) where the fire retardant foam or powder is an expanding firefighting foam.

6) A construction material which incorporates a meltable casing in a manner consistent with the description included within this document.

7) A construction material as described in claim 6, where the meltable casing consists of a composition of Chlorinated Paraffin.

8) A construction material which incorporates a lattice framework, which divides the construction material or certain component parts of the aforementioned construction material into cellular subunits, in a manner consistent with the description included within this document.

9) A construction material which incorporates a lattice framework as described in claim 8, in which the lattice framework divides a fire retardant material such as described in claim 4 into cellular subunits.

10) A construction material as described in claim 1 which incorporates a lattice framework in a manner consistent with claim 8.

11) A construction material as described in claim 4 which incorporates a lattice framework in a manner consistent with claim 8.

12) A construction material consistent with the description of such within this document, which incorporates a fire or heat resistant backboard, designed to prevent airflow in the event of the deformation of other portions of the construction material.

13) A construction material as described in claim 1, which incorporates a fire or heat resistant backboard as described in claim 12.

14) A construction material as described in claim 4, which incorporates a fire or heat resistant backboard as described in claim 12.

15) A construction material as described in claim 6, which incorporates a fire or heat resistant backboard as described in claim 12.

16) A construction material as described in claim 8, which incorporates a fire or heat resistant backboard as described in claim 12.

17) A construction material formatted for use in a suspended ceiling which consists of a fire retardant core (which may consist of powder, foam or any other suitable material) embedded within a meltable casing.

18) A construction material formatted for use in a suspended ceiling which consists of a fire retardant core (which may consist of powder, foam or any other suitable material) embedded within a meltable casing, as described in claim 17, which incorporates a fire retardant material as described in claim 4.

19) A construction material formatted for use in a suspended ceiling which consists of a fire retardant core (which may consist of powder, foam or any other suitable material) embedded within a meltable casing, as described in claim 17, which incorporates a meltable casing as described in claim 6.

20) A construction material formatted for use in a suspended ceiling which consists of a fire retardant core (which may consist of powder, foam or any other suitable material) embedded within a meltable casing, as described in claim 17, which incorporates a lattice framework as described in claim 8.

21) A construction material formatted for use in a suspended ceiling which consists of a fire retardant core (which may consist of powder, foam or any other suitable material) embedded within a meltable casing, as described in claim 17, which incorporates a fire or heat resistant backboard as described in claim 12.
